(19) United States
(12) Patent Application Publication
(10) Pub. No.: US 2002/0091178 A1
(43) Pub. Date: Jul. 11, 2002

(54) Polyvinyl chloride composition

(76) Inventor: Hossein Amin-Javaheri, Houston, TX (US)

Correspondence Address: Attn: James H. Riley II, SHOOK, HARDY & BACON L.L.P., 600 Travis Street, Suite 1600, Houston, TX, 77002-2911, US

(21) Appl. No.: 09/755,211

(22) Filed: Jan. 5, 2001

(51) Int. Cl. C09K 3/00

(52) U.S. Cl. 524/13

(57) ABSTRACT

The present invention relates to a polyvinyl chloride (PVC)/wood composition and more particularly to a PVC/wood composite suitable for the manufacture of window blinds and other PVC/wood products. A compound containing wood powder is added to a PVC base, and a high concentration of titanium oxide, e.g., from about 5 to about 20 wt %, is added to the mixture to make it white. Additional pigments can be added to make the formulation any desired color.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

This invention relates to PVC compositions used to manufacture a variety of PVC based material, specifically, that for use in the manufacture of slats for window blinds. More particularly the invention relates to a PVC/wood chip composition that can be processed in any desired color. This composition eliminates the present requirement to overlay the PVC/wood chip material with PVC in order to mask the brownish color that results from using the current PVC/wood compositions.

2. Description of the Related Art

PVC/wood composite compounds are used to manufacture a variety of everyday household products. The advantage that PVC/wood composite has over ordinary PVC is that the finished product looks and feels more like real wood than plastic. The most common way to manufacture such products is by the extrusion process. For example, U.S. Pat. Nos. 5,539,027, and 6,103,791 relate to processes for producing PVC and wood composites. These products include windows, doors, and window blinds. Products made from these PVC/wood composites are prevalent in the construction industry because of their low cost, resistance to deterioration, and resistance to fire. However, upon initial processing, these PVC/wood composites produce a material that is brownish in color. Because this brown color is usually not desired, a second manufacturing step is required in which the PVC/wood composite material is covered with a thin layer of PVC to give the desired color, usually white. This PVC coating is usually applied in a co-extrusion process. There are significant economic disadvantages, such as higher labor, material and manufacturing costs, that result from having to cover the brownish colored PVC/wood composite with a PVC coating. One additional disadvantage of the prior art coating method is that the desired color is only on the exterior so when the product is cut, such as slats for window blinds, the ends of the product are not coated. The product must be painted in order to conceal the brownish interior.

The present PVC/wood compound is one that upon initial processing produces a product that has the desired color throughout the product. For example, the present PVC/wood compound can be made in a solid white color or it can be pigmented to any desired color. Adding high concentrations of titanium dioxide (TiO₂) to the PVC/wood composition makes the PVC formulation white. Adding additional pigments can make the white PVC formulation any desired color. Titanium dioxide has been used in low concentrations in many PVC compositions as a weathering agent, but has never been used in such concentrations as used in the present composition in order to produce the effect of turning PVC/wood composites from brown to white.

PVC/wood composites that can eliminate the need to add a layer of white PVC offer distinct advantages over existing PVC/wood composites. The advantages include reduced time to manufacture and reduced costs due to the elimination of at least one step in the manufacturing process. Furthermore, because the extruded PVC is a solid color, it can be cut without exposing any color variations in the interior, making it more aesthetically pleasing than the coated prior art product.

### SUMMARY OF THE INVENTION

The primary object of this invention is to provide a PVC/wood composite suitable for the making of window blinds and other PVC based products with the advantages of a solid color upon processing, the elimination of the need to overlay PVC/wood composite products with a layer of PVC, and the elimination of the need for touching up the edges where the product is cut.

The present invention comprises a novel PVC/wood foam composition comprising polyvinyl chloride, a blowing agent(s), a tin stabilizer, a foaming agent, lubricants, a zinc stabilizer, and a whitening agent. The polyvinyl chloride foamed composition can also include any colored pigments as needed. The present invention also comprises the method of forming the polyvinyl chloride/wood foam composition.

### BRIEF DESCRIPTION OF THE DRAWINGS

Not Applicable.

### DETAILED DESCRIPTION OF INVENTION

The present invention provides a PVC/wood foam composition suitable for the manufacturing of window blinds and other PVC/wood products. A PVC/wood foam composition is well suited for the manufacture of window blinds and other similar products because the addition of wood powder changes the texture of the PVC so it looks and feels more like real wood. The disadvantage associated with this wood chip formulation of PVC is that the wood powder imparts a brownish color to the PVC. Some manufacturers use the PVC/wood composition by itself to make a brownish colored slat for use in window blinds. The wood colored slat can be embossed with a wood grain to make it more aesthetically pleasing. More often however, the brownish material is extruded as a substrate for further processing because wood colored slats are not that popular. In a second step or in a co-extrusion process, a PVC layer is put over the entire substrate. Most often, this PVC layer is white and is co-extruded with the PVC/wood composition. In the case of most extruded products, such as slats, the product is cut to size. Not only is this PVC coating layer an extra step which increases costs, but the finished product has a cut end that is unsightly because the brownish base material is visible unless it is touched up with paint which is yet another processing step.

This invention pertains to a composition made from a combination of polyvinyl chloride and wood chips (wood dust) with a high concentration of titanium dioxide in the PVC/wood formulation. The PVC/wood composite used as the primary material can be any commercially available PVC/wood composite. Typically, the present composition comprises about 45%-50 wt % of polyvinyl chloride combined with about 35-40 wt % of a material containing lubricants, a calcium zinc stabilizer and wood powder, about 5-20 wt % of titanium dioxide, and about 5-7 wt % of fillers, tin stabilizers and foaming agents. A preferred mode of practice on the invention uses from about 10 to about 15 wt % of titanium dioxide. The especially preferred mode of practice of the invention uses approximately 45 wt % polyvinyl chloride and about 12 wt % titanium dioxide.

High concentrations of titanium dioxide actually mask the brownish color of the PVC/wood composite and cause the whitening effect. This increase in concentration of titanium dioxide turns the normally brown PVC/wood composition into a solid white composition upon processing. If a color other than white is desired, pigments can be added to the mixture. The whitening properties achieved by the increase in concentration of titanium dioxide eliminates at least one step in the manufacture of PVC/wood composite window blinds and other PVC/wood composite products. It is no longer necessary to coat the brown PVC/wood product with a covering of PVC in order to get the desired color. Additionally, colors other than white are available simply by adding pigment to the whitened mixture.

In accordance with this invention, plastic products, such as window slats, can be manufactured from a PVC material containing wood powder and have whatever color desired. Furthermore, this material is extruded in a single process, is a solid color and can be cut to size without having an unsightly edge.

I claim:

1. A PVC/wood composition comprising PVC, wood powder and about 5 to about 20 wt % titanium dioxide.

2. The PVC/wood composition of claim 1 wherein the titanium dioxide content is about 10 to about 15 wt %.

3. The PVC/wood composition of claim 1 wherein the titanium dioxide content is about 12 wt %.

4. A PVC/wood composition comprising about 45% to about 50 wt % polyvinyl chloride, about 35 to about 40 wt % wood powder, and about 5 to about 20 wt % titanium dioxide.

5. The PVC/wood composition of claim 4 wherein the polyvinyl chloride content is about 45 wt %, the wood powder content is about 38 wt %, and the titanium dioxide content is about 12 wt %.
